(19) United States
(12) Patent Application Publication
(10) Pub. No.: US 2025/0014016 A1
(43) Pub. Date: Jan. 9, 2025

(54) SYSTEMS AND METHODS FOR TRANSACTION-INITIATED CARD FUNDING

(71) Applicant: Snapcommerce Holdings, Inc., Toronto (CA)

(72) Inventor: Hangrui Shi, San Francisco, CA (US)

(73) Assignee: Snapcommerce Holdings, Inc., Toronto (CA)

(21) Appl. No.: 18/676,615

(22) Filed: May 29, 2024

Related U.S. Application Data
(60) Provisional application No. 63/511,764, filed on Jul. 3, 2023.

(51) Int. Cl. G06Q 20/34; G06Q 20/10; G06Q 20/40

(52) U.S. Cl. CPC G06Q 20/349; G06Q 20/10; G06Q 20/4016

(57) ABSTRACT

The present disclosure provides for systems and methods for transaction-initiated funding of payment cards. The described transaction-initiated funding involves a funding pull from funding sources associated with the payment card account during the pendency of transaction. In this manner, the payment card balance or available line of credit may be supplemented during the transaction with at least enough funds to complete the transaction successfully. A user interface on a computer or mobile application may further provide notifications to the user to indicate if funding pulls have been performed.

### CROSS-REFERENCE TO RELATED APPLICATION

This application claims priority to U.S. Provisional Patent Application No. 63/511,764, filed Jul. 3, 2023, which is hereby incorporated by reference in its entirety.

### TECHNICAL FIELD

The present disclosure provides for systems and methods for transaction-initiated funding of payment cards, including credit cards, debit cards, secured cards, and pre-paid cards. The described transaction-initiated funding involves a funding pull from funding sources associated with the card account during the pendency of transaction. In this manner, the card balance may be supplemented in real-time during the transaction with at least enough funds to complete the transaction successfully. A user interface on a computer or mobile application may further, among other functions, provide notifications to the user to indicate if funding pulls have been performed.

### BACKGROUND

Many individuals rely on payment cards for their commerce needs. Declined purchases due to insufficient funding in the principal account, or insufficient credit limit, negatively impact both customers and retailers because customers are not often able to easily add funds to their account while at the point of sale. If the customer cannot make the purchase, the retailer loses profits. In many cases, the customer does have sufficient funding/credit available, but has not preemptively transferred the funds to the card account. Therefore, unless the customer knows ahead of time that they must make a transfer in order to use their card, they will be unable to make purchases which may be essential.

The present disclosure relates to systems and methods for transaction-initiated account funding. If a customer does not have sufficient funding or available credit on their card, said systems and methods may automatically perform a transfer of funds (i.e. a funding pull) from a linked funding source in an amount sufficient to cover the initiated, pending transaction. Advantageously, the automatic transfer of funds occurs within the period of time allowed for transaction approval in real time—from the consumer perspective at the point of sale, the transaction will go through despite the funds or credit limit of the card initially being insufficient. Both debit cards and bank accounts (via automatic clearing house ACH transfers) may be used as funding sources, or alternatively or additionally other funding sources having available funds/credit. Furthermore, said systems and methods may include user applications running on a mobile computing device which may notify users when a transaction-initiated transfer of funds has occurred. The present disclosure provides customers with a much-needed solution for card-based transactions

### SUMMARY

The disclosure herein generally relates to systems and methods for transaction-initiated funding of cards. While it should be apparent, the provided disclosure describes various features and attributes of various embodiments of such systems and methods. It can be appreciated that such features and attributes may advantageously be incorporated in various embodiments without departing from the scope of the disclosure.

In an embodiment, the present disclosure provides for a method for transaction-initiated funding of a payment card, comprising:
receiving an indication that a payment card has an available balance smaller than a dollar amount of a pending transaction;
selecting one or more funding sources having available funds greater than or equal to a remainder of the available balance of the payment card subtracted from the dollar amount of the pending transaction;
one or more of:
   i) initiating a transfer of funds of a dollar amount greater than or equal to the remainder from one or more funding sources to the payment card balance; and
   ii) initiating a transfer of funds of a dollar amount greater than or equal to the remainder from one or more funding sources to an intermediate account, and transferring a dollar amount greater than or equal to the remainder from the intermediate account to the payment card balance; and
approving the pending transaction.

In an embodiment, the method further comprises associating one or more of the funding sources with the payment card to permit transfers of funds from the one or more funding sources to the payment card.

In an embodiment, the method further comprises associating one or more of the funding sources with an intermediate account to permit transfers of funds from the one or more funding sources to the intermediate account; and associating the intermediate account with the payment card to permit transfers of funds from the intermediate account to the payment card.

In an embodiment, the one or more funding sources are associated with one or more of:
i) the payment card, to permit transfers of funds from the one or more funding sources to the payment card; and
ii) the intermediate account, to permit transfers of funds from the one or more funding sources to the intermediate account.

In an embodiment, the available funds of the one or more funding sources are based upon one or more of an actual account balance of the funding source, and a cached value of an account balance of the funding source.

In an embodiment, the pending transaction remains pending for a transaction timeout period, after which the pending transaction is automatically declined.

In an embodiment, the transaction timeout period begins when the card is used at a point of sale.

In an embodiment, a funding pull timeout period begins upon receiving an indication that a payment card has an account balance smaller than a dollar amount of a pending transaction.

In an embodiment, the funding pull timeout period is about 3-5 seconds.

In an embodiment, the pending transaction is approved in real time within the timeout period.

In an embodiment, the funding sources include one or more of a debit card and a bank account.

In an embodiment, the funding sources include one or more of a debit card, bank account, credit card, and secured card.

In an embodiment, the method further comprises comparing the remainder to a threshold value associated with the payment card and, if the remainder is larger than the threshold value, declining the pending transaction.

In an embodiment, the dollar amount greater than or equal to the remainder of the available balance of the payment card includes the remainder and one or more of transfer fees and a tolerance amount.

In an embodiment, the transfer fees are fixed, or depend upon the funding source.

In an embodiment, the tolerance amount is fixed or a percentage of the remainder.

In an embodiment, a risk analysis is performed on the one or more funding sources prior to transferring funds to the payment card.

In an embodiment, only the lowest risk funding source is used for transferring funds to the payment card.

In an embodiment, a risk analysis is performed in parallel with transferring funds to the payment card.

In an embodiment, the risk analysis includes assigning a risk score to each funding source.

In an embodiment, a first risk score for a first funding source and a second risk score for a second funding source are compared to determine which of the first and second risk scores are larger.

In an embodiment, if a first risk score is larger than a second risk score, the funds transferred from the first funding source are cancelled and rolled back if funds are successfully transferred from the second funding source.

In an embodiment, the present disclosure provides for a system for transaction-initiated funding of a payment card having an insufficient balance for a pending transaction, comprising:
a user account having associated with it a payment card, the user account having one or more associated funding sources from which a transfer funds can be initiated;
a payment platform configured to validate a pending point-of-sale transaction of the payment card, the payment platform operable to generate a transaction request, wherein the transaction request includes a transaction denial due to insufficient funds on the payment card;
a client platform separate from or integrated with the payment platform, the client platform operable to:
   receive the transaction request indicating that the payment card has an account balance smaller than a dollar amount of a pending transaction;
   select one or more funding sources associated with the user account having available funds greater than or equal to a remainder of the payment card balance subtracted from the dollar amount of the pending transaction;
   one or more of:
   i) initiate a transfer of funds of a dollar amount greater than or equal to the remainder from one or more funding sources to the payment card balance; and
   ii) initiate a transfer of funds of a dollar amount greater than or equal to the remainder from one or more funding sources to an intermediate account, and transfer a dollar amount greater than or equal to the remainder from the intermediate account to the payment card balance; and
   approve the transaction request to authorize the pending point-of-sale transaction to be completed.

In an embodiment, the system further comprises an application running on a processor of a mobile computing device, the application providing access to the user account.

In an embodiment, a push notification to the user of the mobile computing device is generated upon the transfer of a dollar amount greater than or equal to the remainder, to the payment card account.

In an embodiment, an SMS or email notification to the user of the mobile computing device is generated upon the transfer of a dollar amount greater than or equal to the remainder, to the payment card account

In an embodiment, the client platform is configured to approve the transaction request in real-time prior to the point-of-sale transaction timing out.

### BRIEF DESCRIPTION OF THE DRAWINGS

Aspects and advantages of the present disclosure will become apparent from the following exemplary embodiments taken in conjunction with the accompanying drawings, of which:

FIG. 1 depicts an embodiment of transaction approval and a transaction-initiated funding pull in the client platform.

FIG. 2 depicts an embodiment of a transaction-initiated funding pull at the client platform.

FIG. 3 depicts a further embodiment of a transaction-initiated funding pull.

FIG. 4 depicts a further, alternative embodiment continuing from the funding sources available element of the embodiment of FIG. 3.

### DETAILED DESCRIPTION

Various types of cards are used by customers, and many customers use cards as their primary means to make purchases at stores and other points of sale. Such cards may be referred to as “payment cards” or simply “cards” and may be used at a point of sale to make a purchase, including at stores, online platforms, etc. A “card” or payment card (i.e. the principal account) will typically have an “available balance”. For a debit card, an available balance may be a dollar amount held within its associated checking account, savings account, or other associated account. For a credit card, an available balance may be the remaining credit or remaining line of credit (i.e. the dollar amount available before the user hits their credit limit). For a secured card, the available balance may be the dollar amount available before the card balance hits the security deposit amount, or alternatively or additionally a line of credit if applicable. For a pre-paid card, the available balance may be the remaining dollar amount loaded onto the card.

However, in cases of low account balances (for example, with a debit card or pre-paid card) or nearing a credit limit (for example, with a credit card), a customer may be simply unable to make an essential purchase if they have not pre-emptively checked their account balances and made transfers to cover their purchases. Moreover, customers might even make a pre-emptive transfer but not anticipate the total amount of their purchase. The current situation for these customers is a guessing game, and customers can only hope that they have made transfers in the correct amount to cover planned purchases.

Cards require frequent monitoring of the account balance to ensure that enough funding or credit is available for desired purchases. Users often know their approximate balance, but even if they are off by a small amount, their purchase which they thought they could afford may be declined due to insufficient funds. In order to add more funding or credit to the card, the user would need to manually initiate a transfer of funds which may take significant time and which may not be possible while standing in the checkout line at a retailer.

The present disclosure provides for transaction-initiated funding of cards. The card is generally associated with a user account. The user may provide funding sources for card, including debit cards and bank accounts. Debit cards transactions to fund the card may be processed as a typical debit card payment. Bank account transfers may be performed by an automatic clearing house (ACH) transfer, for example. Other funding sources may include credit cards, secured cards, etc. The user may manually fund the card from any chosen funding account. Additionally, the user may permit one or more funding sources to be used for transaction-initiated funding in case they have insufficient funds during a transaction. The user may set a prioritization of their accounts to ensure that funds are drawn from a desired account.

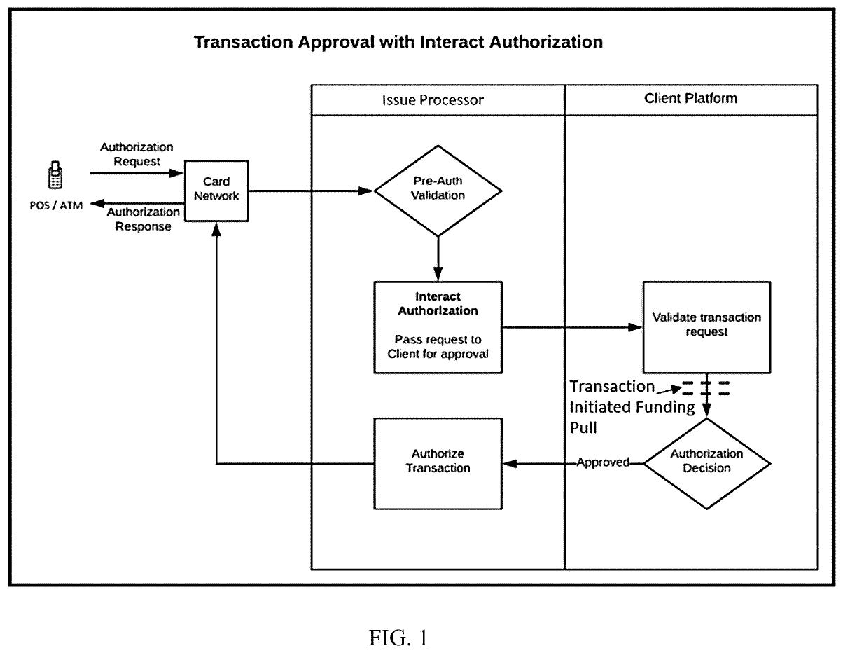

An exemplary transaction is shown in FIG. 1. Generally, a card user will swipe their card (alternatively, using a chip reader or tap), at a point-of-sale (POS) or ATM. The card is associated with a particular card network such as Visa® or Mastercard®, or other card network. The card network will pass the transaction request to a payment platform which validates the transaction request and passes it to the card client platform for approval. The payment platform may return a response (approval or denial of transaction) to the client platform along with a reason code. The reason code may indicate the reason why the transaction was approved or denied. For example, if the reason code indicates insufficient funding in the primary account, the client platform may recognize this reason code and attempt to perform a transaction-initiated funding pull. The client platform then makes a decision to either approve or decline the transaction request, typically on the basis of available funds or credit. If an approval is received from the client platform, the payment platform will authorize the transaction and, in turn, the payment/withdrawal will be processed at the POS or ATM.

The term “payment platform” as used herein may alternatively be referred to as an “issuer processor”. The payment platform generally functions to validate the payment with the issuing bank. The payment platform(s) of the present disclosure generally provide for an “interact authorization” which involves an interaction with the separate or integrated client platform (i.e. the platform which can provide for transaction-initiated funding pull(s) if necessary). In a general sense, a payment platform may include one or more of transaction processing, authorization and clearing, and settlement. Transaction processing may include initially handling or capturing transaction data and securely routing or communicating transaction data to an issuing bank. Authorization and clearing may generally include ensuring that the cardholder has sufficient funds to cover the transaction. As described herein, transaction-initiated funding pulls as performed by the client platform provide a mechanism for completing the transaction even if the traditional authorization process would have denied the transaction. Settlement may generally include transferring funds from the cardholder's bank to the merchant's bank, and typically completes within a few days of the transaction.

However, FIG. 1 illustrates a major issue for customers. After the “validate transaction request” step, the “Authorization Decision” follows and, in the case of insufficient funds on the card, the transaction will be declined. Most customers will have misjudged their card balance or available credit by only a small amount, and there is no option to correct such a deficiency to allow the transaction to proceed. In cases of an insufficient balance, the present disclosure realizes the advantages to initiate a funding pull in real time before the authorization decision is issued such that the transaction can be approved and processed with transaction-initiated funding by the funding pull.

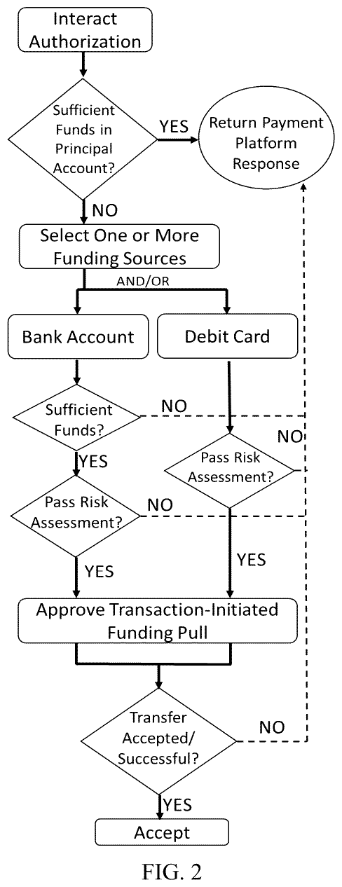

FIG. 2 depicts an exemplary embodiment of the present disclosure. The user would swipe their card at a POS to initiate the transaction. If the card has sufficient credit or funding, the transaction would be approved. Where the systems and methods include a step of determining whether there are sufficient funds in the principal account, it is intended that the “funds” are a balance or credit limit depending upon the principal account type for the payment card (i.e. credit limit for a credit card, balance for a debit card, etc.). If the funding/credit (i.e. funds of the principal account) is insufficient, the card platform will determine whether a funding source is available. If so, a funding source will be selected. In an embodiment, the funding source is selected based upon available account balance. In an embodiment, the funding source is selected based upon a user preference. In an embodiment, the funding source is selected based upon a risk assessment. In an embodiment, the funding source is prioritized based upon funding source type. In an embodiment, a debit card may be prioritized over a bank account due to transfer speed. In an embodiment, funding sources may be ranked based upon one or more criteria (such as account balance, risk, transfer speed, history of successful transaction, account age, account activity, account ownership such as sole vs. joint, account banking institution, etc.) in order to identify the most optimal funding source(s) for use in a transaction-initiated funding pull.

In an embodiment, the client platform receives an indication that a card has a balance or available credit smaller than a dollar amount of a pending transaction. This indication can be received from a separate or integrated payment platform as a reason code or other indication, or may be determined by the client platform directly by comparing account balance to transaction amount.

Generally, a dollar amount transferred in the funding pull is greater than or equal to a remainder of the card balance subtracted from the dollar amount of the pending transaction, as shown in Eqn. 1. Alternatively, in the case of credit cards, the card balance would be replaced by available credit.

$$Remainder \geq Transaction Request Amount - Card Balance \qquad ( Eqn . 1 )$$

In an embodiment, the funding pull is the remainder. In an embodiment, the funding pull is greater than the remainder. In an embodiment, the funding pull is a fixed number (e.g. $25). In an embodiment, the funding pull is performed in increments of a fixed number such as increments of $5 or increments of $10. A funding pull may also take into account an overage for a transfer fee. For example, a transfer fee may be associated with a funding pull transfer from a debit card or bank account. Additionally or alternatively, a tolerance amount may be included as an additional buffer. The tolerance amount may be a fixed amount, a percentage of the funding pull, or any other relatively small amount of additional funding added to the remainder.

In an embodiment, the funding pull includes one or more of the remainder, total fee amount, and tolerance amount. In an embodiment, the funding pull includes the remainder and one or more of the total fee amount and tolerance amount. In an embodiment, the funding pull includes each of the remainder, total fee amount, and tolerance amount as shown in Eqn. 2.

$$Funding Pull = Remainder + Total Fee Amount + Tolerance amount , \qquad ( Eqn . 2 )$$

In the case where a debit card is used for the funding pull, the transaction request may be initiated on that debit card as per FIG. 1, where the client platform acts as a POS requesting a purchase. Optionally, a risk assessment platform may be used to further verify whether the transaction should proceed. Many aspects may be considered by a risk assessment platform in an effort to avoid risk of fraud. For example, the risk assessment platform may consider one or more of IP address, device initiating the transaction, user information, the card primary account number (PAN), address verification system (AVS), card verification value (CVV), and other factors. A risk assessment platform may instruct the client platform to proceed or to not proceed with the transaction based upon these or other factors.

In an embodiment, the risk assessment involves analyzing various factors which can indicate potential fraudulent activity. Each factor can be assigned a certain weight based on its significance, and these weights can be combined to give a numerical risk score. This score can then be used to make decisions about whether to authorize the transaction, require additional verification, or block the transaction altogether. It should be appreciated that, while various risk assessment technologies can be separately used to assess a risk for the merchant, the risk assessment of the present disclosure may be performed on the user's own funding sources in real-time for making decisions on transaction-initiated funding pulls. In this manner, risk for the client platform, and not the merchant, is assessed for the purposes of transaction-initiated funding pull(s).

Various risk factors which may be factored into a risk analysis. Exemplary risk factors, in no particular order, are described below:

IP address: If an IP address is associated with suspicious activity or comes from a region known for fraud, this can increase the risk score. Additionally, IP address history may be assessed to determine whether or not the user's request is anomalous. In the context of transaction-initiated funding pulls, an IP address typically associated with the payment card maybe compared to an IP address typically associated with one of the transaction-initiated funding sources. Alternatively, an IP address of the user account on the client platform may be compared to IP address(es) associated with the available funding sources to assess risk.

Device assessment: Information about the device, such as the type, operating system, and whether it has been used for previous transactions, can be used to assess risk. A new or unrecognized device may be considered more risky and may increase the risk score. A device associated with the payment card and/or client platform may be compared with device(s) associated with the available funding sources to assess risk.

User information: This can include a user's account age, transaction history, and behavior patterns. Sudden changes in behavior or transactions that do not align with a user's typical patterns can increase the risk score. For example, the user information associated with the payment card may be compared with the user information of the client platform and/or funding source(s) to assess risk.

Card Primary Account Number (PAN): If a PAN has been used in previous fraudulent activities or associated with suspicious behavior, it can increase the risk score. For example, a funding source having a PAN which is associated with fraudulent activities may indicate risk.

Address Verification System (AVS): The AVS checks whether the billing address provided by the user matches the address on file with the card issuer. If it doesn't match, this may indicate potential fraud and may increase the risk score. The information on the funding source provided to the client platform by the user (manually or by direct account access) can be verified or additionally compared to the payment card information to assess risk.

Card Verification Value (CVV): If a user repeatedly enters the wrong CVV, this could suggest they don't have the physical card in their possession, which raises the risk and may increase the risk score.

Email Address: Checking the age and domain of the email address associated with the funding source account can be used to assess risk. For instance, brand new email accounts or emails from domains associated with high levels of spam or fraudulent activity can increase the risk score.

User Behavior Analysis: This includes patterns in purchasing behavior, login frequency, time spent on site, mouse movement, keystroke dynamics, and more. Unusual behavior compared to the user's normal habits can signify a higher risk and can increase the risk score.

Payment Method History: If the customer frequently changes or adds/removes funding sources that have been associated with fraudulent activities in the past, this can increase the risk score.

Funding Source Type: Certain types of funding sources may carry a higher degree of risk for the client platform. For example, a credit card may in some cases carry a higher degree of risk than a debit card or bank account. Certain funding sources may be considered highly risky, such as pre-paid or “gift” credit cards, cards or accounts associated with certain financial institutions, etc.

Phone Number: Analyzing the phone number linked to a funding account can be used for risk analysis. For instance, if the country code of the phone number doesn't match the country of the user or the IP address, this could indicate risk. Similarly, if the phone number is new or frequently changing, this could also suggest a higher risk. Certain risk assessment systems can even check whether a phone number has been associated with fraudulent activity in the past. VoIP (Voice over IP) numbers or temporary “burner” phone numbers can also pose a higher risk.

Other factors: Other factors could include the size and frequency of the transaction, the type of purchase, the location of the merchant, the time of the transaction, etc.

A combination of machine learning algorithms and rule-based systems can be used to assign weights to these factors and calculate the risk score. Machine learning algorithms can analyze past transaction data to predict which funding sources carry relatively high risk. Rule-based systems, on the other hand, use predefined rules (e.g., “if the address associated with the funding source does not match the address associated with the payment card account and/or client platform account, then increase the risk score by Y”).

Once a risk score is calculated, in an embodiment, it can be compared to predefined thresholds to determine the appropriate action. For example:

If the risk score is below a certain threshold, the transaction-initiated funding pull could be approved automatically.

If the risk score is above a certain threshold, additional verification could be required (such as a two-factor authentication). This additional verification would not occur within the pending transaction window, however authentication could be used to verify a funding source so that the transaction-initiated funding pull could be successfully performed at a future instance. Alternatively, a risk analysis may be performed when a user associates the funding source with the client platform account so that any required authentication may be completed in advance of a purchase. Certain risk factors may require authentication prior to use as a funding source (for example, in an embodiment, a risky phone number associated with a funding source may need to be verified before a transaction-initiated funding pull would be approved from that funding source). If the risk score is significantly high, the funding source could be blocked entirely for use in transaction-initiated funding pulls.

If the transaction is otherwise approved to proceed, the funding pull will be initiated so that at least enough funds to cover the purchase will be transferred to the card, optionally taking into account fees and/or a tolerance amount. If the funding pull is successful, the transaction will be approved and the user's purchase will be completed at the POS as if there had been sufficient funds on the card initially.

From the client platform perspective, including an additional risk assessment reduces risk. Risk may be further reduced by, as described herein, running risk analysis on two or more available funding sources in parallel. By doing so, the funding pull may be performed from a funding source having a lowest risk assessment. Running two or more risk assessments in parallel also provides the advantage of reducing latency in cases where a funding source is declined by the risk analysis platform. By reducing latency, there is an increased chance that the funding pull, if approved, will be successfully be completed within the timeout period for the transaction (for example, about 4 seconds in some embodiments).

If a bank account is used as the funding source, then an ACH transfer may be used instead of a debit card payment to fund the card in the funding pull. However, ACH transfers take time to initiate and process. Even further, fetching live account balance information takes approximately 30 seconds whereas a transaction timeout is typically less, such as about 3-5 seconds. To overcome these issues, the present systems may include an intermediate account to provide funding to the payment card. The intermediate account may transfer funds to the payment card and may therefore cover the funding pull for the period of time during which it takes for the ACH transfer to clear.

For ACH transfer funding pulls, it may initially be determined whether there are enough funds in the bank account. Due to the live account balance time limitations, it may be necessary to use cached account balances updated automatically throughout the day, for example every 2-3 hours. A risk assessment platform may be employed in order to provide a risk-guided decision for authorizing the transaction. Once approved, funds may be transferred from an intermediate account to the payment card to fund the card for the transaction.

Use of intermediate accounts are not necessarily limited to bank accounts or ACH transfers. In certain embodiments, an intermediate account may be used to accept transfers of funds from a credit card, debit card, secured card, etc. and the intermediate account may be used to transfer funds to the payment card during the pending transaction. A funding source may generally be “associated with” one or more of the payment card account or the intermediate account. If two accounts are “associated” it is intended, at least, that a transfer of funds may be initiated from one account to another. In an embodiment, one or more of a debit card, credit card, bank account, secured card, or other funding source are associated with one or more of the payment card or an intermediate account. Use of an intermediate account generally involves initiating a transfer from the intermediate account to the payment card, and initiating a transfer from the funding source to the intermediate account. It should be appreciated that the transfers may be initiated concurrently or sequentially unless specified. In an embodiment, the transfers are initiated concurrently. In an embodiment, the transfers are initiated sequentially. In an embodiment, the transfers are initiated sequentially with the transfer from intermediate account to payment card being initiated first. In an embodiment, the transfers are initiated sequentially with the transfer from funding source to intermediate account occurring first. It should also be appreciated that the “initiated transfer” from the bank account to the intermediate account will take time to clear and ultimately settle as described herein. It is also contemplated that an intermediate account may be used to fund a payment card during the transaction pendency, and the transfer from the funding source to the intermediate account may be initiated after the funding pull has completed.

In an embodiment, a funding pull threshold may be implemented. For example, a funding pull may only be initiated where the funding pull is smaller than some threshold value. In an embodiment, the funding pull threshold may be about $10, or about $50, or about $100. In an embodiment, the funding pull threshold may be set by the user or by the client platform. In an alternative embodiment, the funding pull threshold may be based on a calculation of the user's linked assets where more assets allows for a larger funding pull threshold. The funding pull threshold may also vary based upon the type of funding source. For example, a debit card funding source may have a larger threshold than a bank account funding source requiring ACH. Alternatively, an ACH funding source may have a larger than a threshold. In some embodiments, the risk analysis platform may be used to assign a threshold for each funding source based upon a risk assessment. In an embodiment, the threshold may be determined or analyzed periodically or on a transaction-by-transaction basis. In an embodiment, the threshold is determined by the risk analysis platform at least daily. In an embodiment, the threshold is determined by the risk analysis platform in the first transaction of the day. In an embodiment, the threshold is determined by the risk analysis platform at each transaction.

In an embodiment, the risk analysis platform may generally lead to four potential outcomes. First, if the funding source has sufficient balance or credit, and the fraud checks pass, the funding pull transfer will be successful. Second, if the funding source has insufficient balance or credit, and the fraud check fails, the funding pull transfer will fail. Third, if the funding source has insufficient balance and the fraud check passes, the funding pull transfer will fail. Fourth, if the funding source has sufficient balance or credit and the fraud check fails, there will be a rollback or refund of the authorization and transfer to the funding source, and the funding pull transfer will as a result fail. In an embodiment, a rollback or refund is required because the risk analysis may be performed in parallel with the funding pull transfer.

In various embodiment, various degrees of parallelization may be included to reduce latency. By reducing latency, there is an increased chance that the funding pull, if approved, will be successfully be completed within the timeout period for the transaction (for example, about 4 seconds in some embodiments). For example, two or more risk assessments may be performed on two or more different funding sources in parallel. In further embodiments, a risk assessment may be performed in parallel with a funding pull. In further embodiments, two or more risk assessments on two or more funding sources may be performed in parallel with at least one funding pull from one of the two or more funding sources. In further embodiments, risk assessment and funding pulls may be performed in parallel for all accessible, available, or linked funding sources.

In further embodiments, funding pull threshold may be static or dynamic. In an embodiment, the funding pull threshold is static and only changes when the user or alternatively the client platform changes the threshold value manually or upon user request. In an embodiment, the funding pull threshold is dynamic and may vary depending upon the amount of additional funding that a user has required via funding pull for the day, multiple days, week, month, etc. In another embodiment of a dynamic funding pull threshold, the user may be allotted a certain amount of funding pull over a time period (day, week, month, etc.) and the threshold may be reduced by each subsequent funding pull. In an alternative embodiment, the funding pull threshold is increased or reset when the user makes a normal payment on the card in order to replenish the balance.

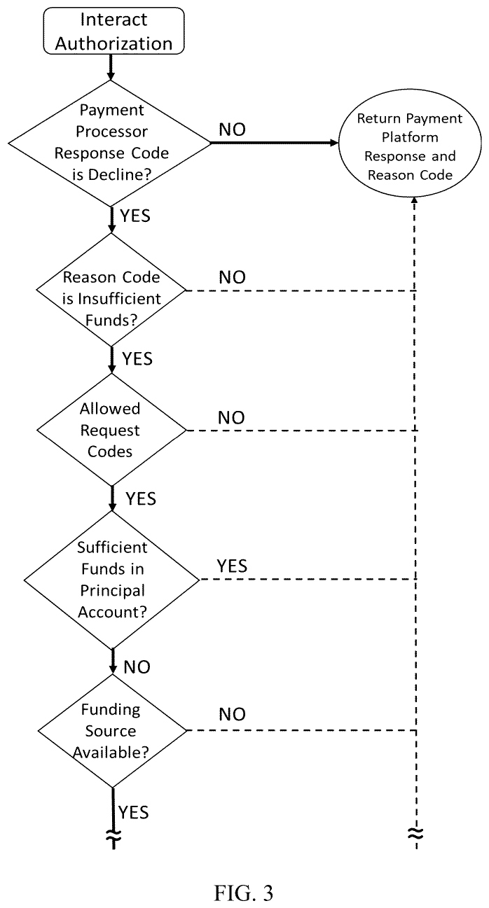

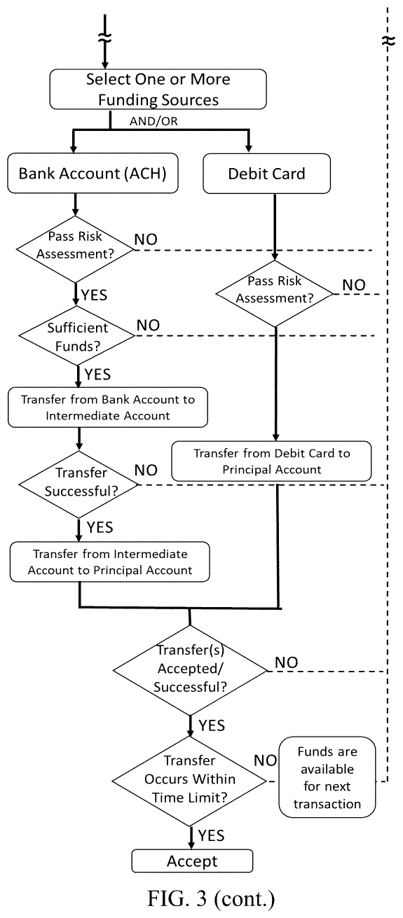

An embodiment of the present disclosure is depicted in FIG. 3. After attempting to make a purchase, the payment platform may either decline or accept the transaction. If the transaction is accepted, then the payment card had sufficient funding and the transaction can proceed. If declined, the reason (reason code) for the transaction being declined is determined. If the reason is not because of insufficient funds, then the transaction is declined. An optional step may include assessing whether or not the request is an allowed request code, i.e. a relevant purchase request and not an irrelevant request at the purchase processor such as a refund request or a simple verification request. However, if the reason from the payment platform is because of insufficient funds, then the client platform may further determine whether there are enough funds on the card to either proceed with the transaction or to look to check other funding sources for available funding.

In an embodiment of FIG. 3, funding sources such as ACH transfer from a bank account may be available as well as debit cards. In an alternative embodiment of FIG. 3, a debit card is the only funding source type. In an embodiment, if the debit card and/or bank account has available funding and passes risk assessments, funds to cover the purchase may be transferred. Generally, if the transfers are all unsuccessful, then the transaction will be declined. However, if one or more of the transfer are successful, then the transaction could be successful provided that the transfer occurred within the time limit (about 3 seconds). In an embodiment, if the transfer did occur within the time limit, then the transaction will be approved at the POS. In an embodiment, if the transfer did not occur within the time limit, then the funds will be available for the next transaction. In an embodiment, the user may subsequently re-try the transaction at the POS which should be approved because the principal account will have the funds available from the transfer.

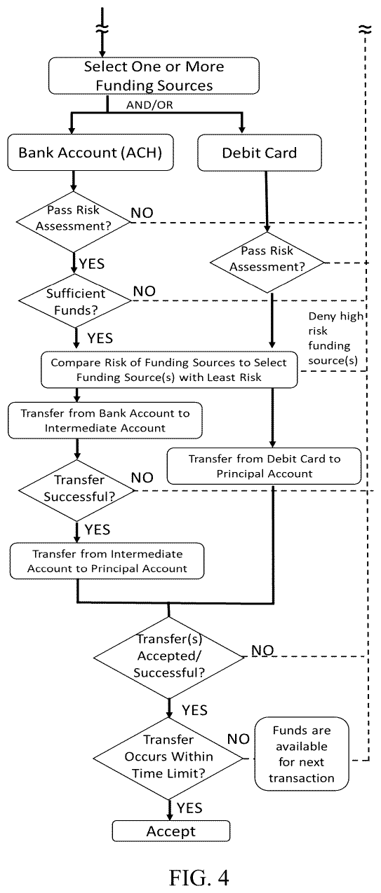

In an alternative embodiment, as depicted in FIG. 4, a risk comparison may be performed prior to the transfer of any funds from a funding source to the principal account. In an embodiment, the least risky funding source is selected for a transfer. In an embodiment, one or more funding sources having relatively low risk are selected. In an embodiment, the risk of each funding source is determined in parallel, i.e. simultaneously. In an embodiment, the bank account may be used if the debit card lacks funds or if the bank account is the default account. In an embodiment, if the bank account is used for the funding pull, it may optionally first undergo a risk analysis. It is then determined whether or not the bank account has sufficient funding-either via a direct inquiry or by accessing cached values of the bank account balance. In an embodiment, if enough funds are available, then an ACH transfer may be initiated from the user's bank account to an intermediate account of the client platform. In an embodiment, the intermediate account is funded by the client platform and has funds available for immediate transfer to the user's payment card account. The ACH transfer may be a same-day transfer or may take more than one day to be completed via batch processing. However, because the intermediate account had immediate funds to transfer, the transaction can be completed if it occurs within the time limit. In an embodiment, if the transfer is successful but does not occur within the time limit, the funds will be available for the next transaction and the user may re-attempt the transaction.

Several alternative embodiments may be advantageously used to provide transaction-initiated payment card funding. In some embodiments, the debit card and bank account funding sources may be validated simultaneously, or in parallel, in terms of risk and/or available funding. The parallel validation may increase the chances that a successful transfer will be performed before the transaction times out. A user may have more than one debit card or more than one bank account and any or all funding sources can be validated in parallel or individually. In another embodiment, the funding pull may be split between two or more funding sources. For example, if a debit card is available for a portion, but not all, of the funding pull, another source such as a bank account may provide the rest of the funding pull. Alternatively, pre-defined rules could be set for splitting the funding across multiple funding sources. In an alternative embodiment, the risk analysis platform may be used to determine splitting of the funding pull across multiple funding sources. In an alternative embodiment, the risk analysis platform accounts for transfer fees in deciding upon whether to split the funding pull across multiple funding sources. In an embodiment, additional transfer fees incurred due to splitting the funding pull across multiple funding sources may be permissible if one or more of the funding sources is high risk.

In an alternative embodiment, the funding sources are not limited to debit cards and bank accounts and may include any other funding source available for use in a transaction-initiated funding pull. In an embodiment, the funding sources include credit cards or secured cards. In an embodiment, a risk assessment may be performed to assess risk of a credit card or secured card funding source.

The systems and methods herein may include a user interface. A user may create an account associated with the client platform. The user may access their account from a computer or mobile computing device using login credentials such as a username and password, text verification, and/or biometric verification. A user may add funding sources, including debit cards or bank accounts. A user may associate their other payment cards for use at a point-of-sale (such as credit cards, debit cards, pre-paid cards, or secured cards) with the account. Users may also, remove funding sources or modify their funding sources. Users may also set up text, e-mail, or push notifications for various occurrences such as low account balance, low fund availability in a funding source, successful transaction, declined transaction, etc.

In an embodiment, a user may receive a text, e-mail, or push notification that a transaction-initiated funding pull was performed. The notification may be sent immediately upon occurrence of the transfer. A separate or the same notification may alert the user that they have no remaining funding in one of their payment or funding accounts. The notification may provide a link or may be selected to bring the user to their account login.

In some embodiments, users may designate primary, secondary, etc. funding sources for transaction-initiated funding pulls. In an alternative embodiment, the client platform may designate certain funding sources by default such as debit cards. In an alternative embodiment, the client platform may designate the best funded account overall or within a funding source type as default. As described herein, funding pulls may be made in parallel or may be split across multiple funding sources.

### INCORPORATION BY REFERENCE

The entire disclosure of each of the patent documents, including certificates of correction, patent application documents, scientific articles, governmental reports, websites, and other references referred to herein is incorporated by reference herein in its entirety for all purposes. In case of a conflict in terminology, the present specification controls.

### EQUIVALENTS

The invention can be embodied in other specific forms without departing from the spirit or essential characteristics thereof. The foregoing embodiments are to be considered in all respects illustrative rather than limiting on the invention described herein. In the various embodiments of the systems and methods of the present invention, where the term comprises is used with respect to the recited components of the system or steps of the methods, it is also contemplated that the systems and methods consist essentially of, or consist of, the recited steps or elements. Furthermore, it should be understood that the order of steps or order for performing certain actions is immaterial so long as the invention remains operable. Moreover, two or more steps or actions can be conducted simultaneously.

In the specification, the singular forms also include the plural forms, unless the context clearly dictates otherwise. Unless defined otherwise, all technical terms used herein have the same meaning as commonly understood by one of ordinary skill in the art to which this invention belongs. In the case of conflict, the present specification will control.

What is claimed is:

1. A method for transaction-initiated funding of a payment card, comprising:
receiving an indication that a payment card has an available balance smaller than a dollar amount of a pending transaction;
selecting one or more funding sources having available funds greater than or equal to a remainder of the available balance of the payment card subtracted from the dollar amount of the pending transaction;
one or more of:
i) initiating a transfer of funds of a dollar amount greater than or equal to the remainder from one or more funding sources to the payment card balance; and
ii) initiating a transfer of funds of a dollar amount greater than or equal to the remainder from one or more funding sources to an intermediate account, and transferring a dollar amount greater than or equal to the remainder from the intermediate account to the payment card balance; and
approving the pending transaction.

2. The method of claim 1, further comprising associating one or more of the funding sources with the payment card to permit transfers of funds from the one or more funding sources to the payment card.

3. The method of claim 1, further comprising associating one or more of the funding sources with an intermediate account to permit transfers of funds from the one or more funding sources to the intermediate account; and associating the intermediate account with the payment card to permit transfers of funds from the intermediate account to the payment card.

4. The method of claim 1, wherein the one or more funding sources are associated with one or more of:
i) the payment card, to permit transfers of funds from the one or more funding sources to the payment card; and
ii) the intermediate account, to permit transfers of funds from the one or more funding sources to the intermediate account.

5. The method of claim 1, wherein the available funds of the one or more funding sources are based upon one or more of an actual account balance of the funding source, and a cached value of an account balance of the funding source.

6. The method of claim 1, wherein the pending transaction remains pending for a transaction timeout period, after which the pending transaction is automatically declined.

7. The method of claim 6, wherein the transaction timeout period begins when the card is used at a point of sale.

8. The method of claim 7, wherein a funding pull timeout period begins upon receiving an indication that a payment card has an account balance smaller than a dollar amount of a pending transaction.

9. The method of claim 8, wherein the funding pull timeout period is about 3-5 seconds.

10. The method of claim 6, wherein the pending transaction is approved in real time within the timeout period.

11. The method of claim 1, wherein the funding sources include one or more of a debit card and a bank account.

12. The method of claim 1, wherein the funding sources include one or more of a debit card, bank account, credit card, and secured card.

13. The method of claim 1, further comprising comparing the remainder to a threshold value associated with the payment card and, if the remainder is larger than the threshold value, declining the pending transaction.

14. The method of claim 1, wherein the dollar amount greater than or equal to the remainder of the available balance of the payment card includes the remainder and one or more of transfer fees and a tolerance amount.

15. The method of claim 14, wherein the transfer fees are fixed, or depend upon the funding source.

16. The method of claim 14, wherein the tolerance amount is fixed or a percentage of the remainder.

17. The method of claim 1, wherein a risk analysis is performed on the one or more funding sources prior to transferring funds to the payment card.

18. The method of claim 17, wherein only the lowest risk funding source is used for transferring funds to the payment card.

19. The method of claim 1, wherein a risk analysis is performed in parallel with transferring funds to the payment card.

20. The method of claim 19, wherein the risk analysis includes assigning a risk score to each funding source.

21. The method of claim 20, wherein a first risk score for a first funding source and a second risk score for a second funding source are compared to determine which of the first and second risk scores are larger.

22. The method of claim 21, wherein, if a first risk score is larger than a second risk score, the funds transferred from the first funding source are cancelled and rolled back if funds are successfully transferred from the second funding source.

23. A system for transaction-initiated funding of a payment card having an insufficient balance for a pending transaction, comprising:
a user account having associated with it a payment card, the user account having one or more associated funding sources from which a transfer funds can be initiated;
a payment platform configured to validate a pending point-of-sale transaction of the payment card, the payment platform operable to generate a transaction request, wherein the transaction request includes a transaction denial due to insufficient funds on the payment card;
a client platform separate from or integrated with the payment platform, the client platform operable to:
receive the transaction request indicating that the payment card has an account balance smaller than a dollar amount of a pending transaction;
select one or more funding sources associated with the user account having available funds greater than or equal to a remainder of the payment card balance subtracted from the dollar amount of the pending transaction;
one or more of:
i) initiate a transfer of funds of a dollar amount greater than or equal to the remainder from one or more funding sources to the payment card balance, and
ii) initiate a transfer of funds of a dollar amount greater than or equal to the remainder from one or more funding sources to an intermediate account, and transfer a dollar amount greater than or equal to the remainder from the intermediate account to the payment card balance; and
approve the transaction request to authorize the pending point-of-sale transaction to be completed.

24. The system of claim 23, further comprising an application running on a processor of a mobile computing device, the application providing access to the user account.

25. The system of claim 24, wherein a push notification to the user of the mobile computing device is generated upon the transfer of a dollar amount greater than or equal to the remainder, to the payment card account.

26. The system of claim 23, wherein an SMS or email notification to the user of the mobile computing device is generated upon the transfer of a dollar amount greater than or equal to the remainder, to the payment card account

27. The system of claim 23, wherein the client platform is configured to approve the transaction request in real-time prior to the point-of-sale transaction timing out.
